(19) United States
(12) Patent Application Publication
(10) Pub. No.: US 2010/0062133 A1
(43) Pub. Date: Mar. 11, 2010

(54) Blended beverage composition of berry solids, yaupon solids and water

(76) Inventor: Violeta Colova, Tallahassee, FL (US)

Correspondence Address: NORRIS, MELTON & GREGERSEN, PLLC.;Suite 305, 1901 Pennsylvania Avenue, N.W., Washington, DC, 20006, US

(21) Appl. No.: 12/461,804

(22) Filed: Nov. 17, 2009

Related U.S. Application Data
(60) Provisional application No. 61/091,504, filed on Aug. 25, 2008.

(51) Int. Cl. C09K 15/08; A23L 2/02; A23L 2/52; A23F 3/00; C12G 1/00

(52) U.S. Cl. 426/546

(57) ABSTRACT

A blended beverage composition with enhanced polyphenolic antioxidant compounds, comprising:
a) small berry fruit solids;
b) yaupon solids; and
c) water

### FIELD

The present composition pertains to natural blended energizing juice beverages. comprising small berry solids, yaupon solids and water, and claims priority to provisional application number 61/091,504 entitled “Beverage Compositions”, filed Aug. 25, 2008, and hereby expressly incorporates the provisional herein by reference under 35 USC §119.

### BACKGROUND

In an effort to appeal to the growing number of consumers that are concerned about their health and well-being, there are many beverage drink compositions available containing various components that are said to provide physiological effects such as increased memory, enhanced physical performance, improved cellular hydration and increased capacity for the body to break down alcohol.

U.S. Pat. No. 7,279,184 disclose methods for making compositions derived from Ilex species, particularly Ilex paraguariensis, having lowered caffeine and tannin concentrations, compositions made by such methods, oral delivery formulations, and methods of use of such compositions.

Rapid cellular hydration and water distribution within the body is provided by the beverage in U.S. Pat. No. 5,464,619; wherein the beverage comprises: flavanols; sodium ions; potassium ions; carbohydrate that provides fructose and glucose; and water.

U.S. Pat. No. 6,514,544 disclose a beverage to increase the body's capacity to break down alcohol, comprising fructose, at least one component of the vitamin B complex, and taurine.

A food supplement natural product containing high quantities of resveratrol; ellagic acid, and other phenolic compounds and antioxidants is prepared by a dietary grape supplement in U.S. Pat. No. 6,190,716. The product is prepared by the step of crushing muscadine grapes following standard operational procedures. The crushed fruit is processed through one of three distinct methods (Alpha, Beta, Gamma). A third step of the method comprises placing the pomace into a modified, rotary drum dryer at about 180 degrees Fahrenheit and drying the contents to less than 1 percent moisture. The fourth step of the method comprises bagging the dried material into plastic freezer bags and storing in food-grade containers in a room with a temperature of between about 60 degrees and 70 degrees Fahrenheit. The fifth step of the method consists of blending materials produced through Alpha, Beta, or Gamma. Lastly, a fifth step of the method comprises finely grinding the dried materials before encapsulating such material in gelatin capsules or other food products.

U.S. Pat. No. 4,716,044 disclose a process for obtaining juices from fruits containing the same using ultrafiltration, but where it is necessary to only process the fruit to a pumpable fluid puree state, add liquefaction enzymes, if necessary, and thereafter pump the resulting puree of fruit and juice directly through an ultrafiltration system that is defined by a rigid porous housing having a food grade ultrafiltration membrane secured along inside walls of the housing.

Consumers are attracted to these enhanced beverage compositions because, in addition to the advantages stated above, they may also contain components such as fruit extracts or solids that provide added nutritional benefits, such as natural fruits containing high quantities of phenolic compounds and antioxidants.

However, in many instances, these beverage drinks may not have the desired physiological effects or may not be as palatable as desired, due to one or more components that are added or absent from the beverage composition.

For these reasons, there is a need for natural energizing beverage juice compositions comprising a synergistic combination of small berry fruit solids and selected levels of yaupon solids, which provide antioxidants and caffeine and is a healthy and palatable substitute that satisfies consumer demands for a healthy functional food.

### SUMMARY

It is an object to provide natural blended energizing juice beverage compositions comprising small berry solids, yaupon solids and water that contains antioxidants, caffeine that is a healthy and palatable, and satisfies a demand for a healthy functional food.

In one aspect a natural blended energizing juice beverage composition is provided comprising:
a) from about 25% to about 90% small berry fruit solids;
b) from about 10% to about 75% yaupon solids; and
c) water

In another aspect a natural blended energizing juice beverage composition is provided comprising:
a) from about 25% to about 90% small berry fruit solids;
b) from about 10% to about 75% yaupon solids; and
c) water,
   wherein the ratio of berry fruit solids to yaupon solids is about 3:1,

In yet another aspect a natural blended energizing juice beverage composition is provided comprising:
a) from about 25% to about 90% small berry fruit solids;
b) from about 10% to about 75% yaupon solids; and
c) water,
   wherein the ratio of berry fruit solids to yaupon solids is about 4:1.

In an aspect yet further a natural blended energizing juice beverage composition is provided comprising:
a) from about 25% to about 90% small berry fruit solids;
b) from about 10% to about 75% yaupon solids; and
c) water,
   wherein the ratio of berry fruit solids to yaupon solids is about 8:1.

### BRIEF DESCRIPTION OF THE DRAWINGS

FIG. 1 is bar graph showing the amounts of total phenolics in the various juices, blends and “Noble” wine.

FIG. 2 is bar graph showing the total amount of anthocyanins in the various juice blends and “Noble” wine.

FIG. 3 is bar graph showing the total tannins in various juice blends and “Noble” wine.

Please delete the bar graphs of total phenolics, total anthocyanins and total tannins on pages 9 and 10.

### DETAILED DESCRIPTION

The present methods and products may be understood by reference to the detailed descriptions of exemplary embodiments and aspects.

It is to be understood that the terminology used is for the purpose of describing exemplary aspects only and is not intended to be limiting thereto.

It must be noted that as used in the specification and the appended claims, the singular forms “a” “an” and “the” include plural referents unless the context clearly dictates otherwise.

In the specification and claims which follow, reference will be made to a number of terms which is defined to have the following meanings:

Ranges are expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment.

The term “Noble” is meant to describe a variety of muscadine grapes.

The phrase “Noble cold press” is meant to describe the Noble pure juice produced by cold pressing.

The phrase “Noble hot press” is meant to describe the Noble pure juice produced by hot pressing.

The term “herbal drink” is referring to Ilex vormitoria tea, which is naturally caffeinated.

The terms “yaupon” or “yaupon holly” refers to Ilex vormitoria (Iv), a species of the holly plant, which contains caffeine, and is native to southeastern North America, occurring in the United States from Maryland south to Florida and west to Oklahoma (only in the extreme Southeast) and Texas and in Mexico in Chiapas.

The designation “M” in the data summary is meant to refer to the Noble juice.

The term “small berry fruit solids includes the fruit solids of grape, muscadine grape, blue berries, black berries, raspberries, strawberries, pomegranate, and the like.

The symbol °Bx means degrees Brix and is a measurement of the mass ratio of dissolved sugar to water in a liquid.

Various well-known processes are used to extract fruit juice from fruit, including hot press, cold press, CO₂ sterilization and the like. Processes for preparing fruit derived products are well known in the art and are disclosed in U.S. Pat. No. 6,190,716 and 4,716,044.

The following examples are exemplary and are not be construed as limiting.

### EXAMPLE 1

Muscadine Juice Preparation:

Approximately 18 lbs. of muscadine grapes (Noble variety) were cleaned and crushed in the presence of pectin enzyme, heated to about 62° C. and held at that temperature for approximately 30 mins. Thereafter, a hot press was applied to the grape stem, seed and pulp to obtain muscadine juice. The resultant juice was cooled to a temperature of about 8° C. where a precipitate formed. The precipitate was removed and the clear juice obtained was packaged in a container for later use with the other components in the beverage composition.

The characteristics of the juice produced by the process in Example 1 are as follows:

Sugar content 19% °Bx

pH of 3.90

Acidity 0.525 (3.5 ml of NaOH)
Colour-purple

Formed precipitate during cold stabilization

### EXAMPLE 2

### Musacadine Juice Preparation (Cold Process):

When muscadine juice was produced by the cold process, the following characteristics were observed:
Sugar content of 18.2% °Bx
pH of 3.47
Acidity 0.525 w/v

### EXAMPLE 3

3:1 (Muscadine:lv) Juice Blend Ratio

A natural blended energizing juice beverage composition and related data (determination of total phenolics, monomeric anthocyanins and tannins) is provided in the summary below.

### EXAMPLE 4

4:1 (Muscadine:lv) Juice Blend Ratio

A natural blended energizing juice beverage composition and related data (determination of total phenolics, monomeric anthocyanins and tannins) is provided in the summary below.

### EXAMPLE 5

### 8:1 (Muscadine:lv) Juice Blend Ratio

A natural blended energizing juice beverage composition and related data (determination of total phenolics, monomeric anthocyanins and tannins) is provided in the summary below.

### SUMMARY

### Determination of Total Phenolics

### (Folin & Ciocalteu Colorimetric Assay Based on Singleton and Rossi 1965

| | As Gallic acid, mg/l |
|---|---|
| Sample description | Avg: ± st. dev. |
| Noble juice cold | 1360 ± 59 |
| press | |
| Noble juice hot press | 1646 ± 10 |
| Blend juice M:lv 3:1 | 1117 ± 23 |
| Blend juice M:lv 4:1 | 1187 ± 16 |
| Blend juice M:lv 8:1 | 1295 ± 30 |
| Noble wine | 1895 ± 3 |
| Herbal drink | 31 ± 2 |

### Determination of Total Monomeric Anthocyanins by pH-Differential Method (Current Protocols in Food Analysis Chemistry—M. Guisti & R. E. Wrolstad, 2000)

| | As Cyanidin-3-glucoside, mg/1 |
|---|---|
| Sample description | avg. ± st. dev. |
| Noble juice cold | 328 ± 68 |
| press | |
| Noble juice hot press | 564 ± 37 |
| Blend juice M:lv 3:1 | 283 ± 21 |
| Blend juice M:lv 4:1 | 255 ± 23 |
| Blend juice M:lv 8:1 | 258 ± 35 |
| Noble wine | 251 ± 6 |
| Herbal drink | Not detectable |

### Determination of Total Tannins

### Assay by James F. Harbertson and Douglas O. Adams

### Adapted from A. E. Hagerman and L. G. Butler. Protein precipitation method for the quantitative determination of tannins. J. Agric. Food Chem. 26:809-812 (1978)

| | As (+)-Catechin, mg/I |
|---|---|
| Sample description | avg. ± st. dev. |
| Noble juice cold | 24 ± 6 |
| press | |
| Noble juice hot press | 40 ± 6 |
| Blend juice M:lv 3:1 | 27 ± 6 |
| Blend juice M:lv 4:1 | 29 ± I |
| Blend juice M:lv 8:1 | 30¢3 |
| Noble wine | 11 ± 3 |
| Herbal drink | 3 ± 2 |

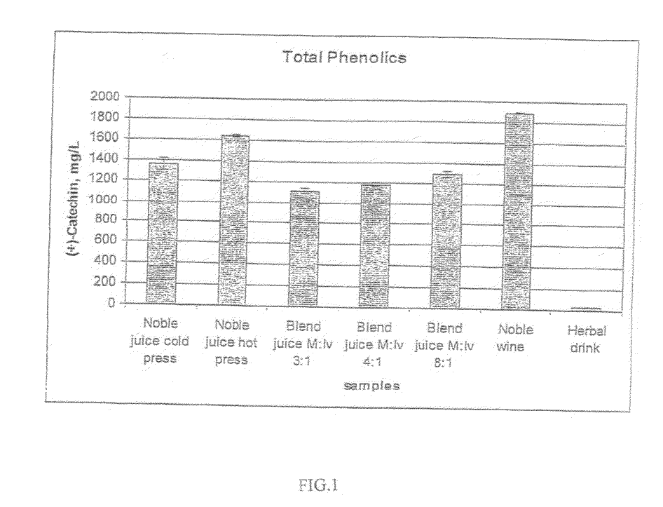

FIG. 1 is a bar graph showing the total phenolics in the “Noble” variety of muscadine grapes from cold and hot pressing, various juice blends, Noble wine and an herbal drink of Ilex vormitoriat, which is naturally caffeinated.

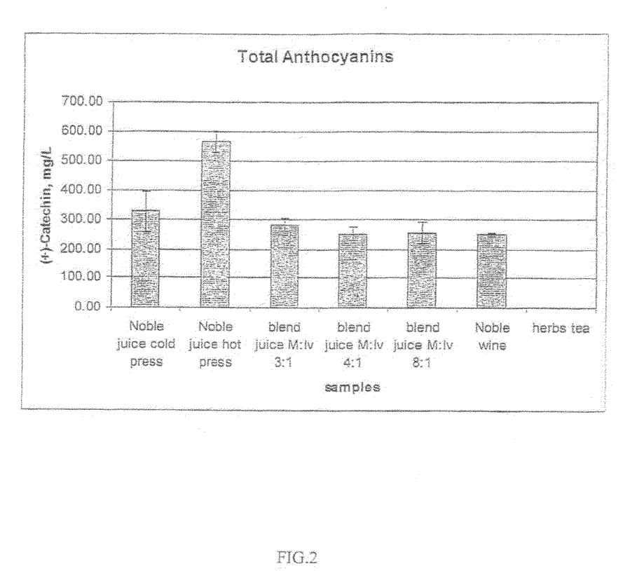

FIG. 2 is a bar graph showing total anthocyanins in “Noble” cold and hot pressed juices, various juice blends, “Noble” wine and herbal tea.

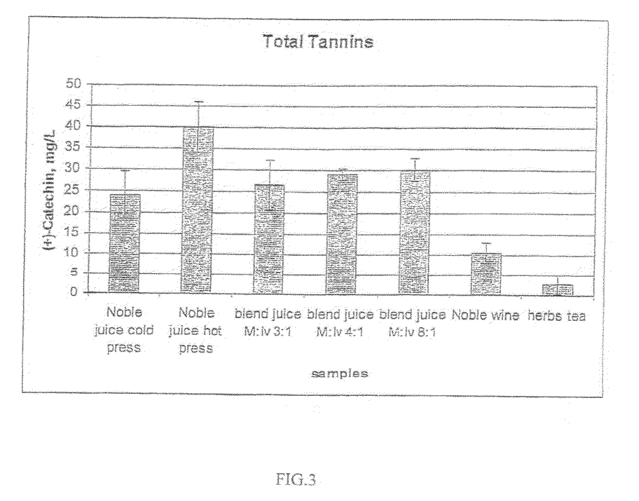

FIG. 3 is a bar graph showing total tannins in “Noble” juices that are hot and cold pressed, juice blends, “Noble” wines and herbal tea.

The above-described embodiments are merely exemplary illustrations of implementations set forth for a clear understanding of the principles of the invention. The previous description of the disclosed embodiments is provided to enable any person skilled in the art to make or use the process and products. Various modifications to these embodiments will be readily apparent to those skilled in the art, and the generic principles defined herein may be applied to other embodiments without departing from the spirit or scope of the invention. Thus, the present innovation is not intended to be limited to the embodiments shown herein but is to be accorded the widest scope consistent with the principles and novel features disclosed herein.

I claim:

1. A blended beverage composition with enhanced polyphenolic antioxidant compounds, comprising:
a) small berry fruit solids;
b) Yaupon solids; and
c) Water

2. The blended beverage composition of claim 1, wherein said berry fruit solids is grape.

3. The blended beverage composition of claim 2, wherein said grape is muscadine grape.

4. The blended beverage composition of claim 1, wherein said berry fruit solids is selected from the group consisting of blue berries, black berries, raspberries, strawberries and pomegranate.

5. The blended beverage composition of claim 1, comprising:
a) from about 25% to about 90% small berry fruit solids;
b) from about 10% to about 75% yaupon solids; and
c) water

6. The blended beverage composition of claim 5, wherein the ratio of berry fruit solids to yaupon solids is about 3:1.

7. The blended beverage composition of claim 5, wherein the ratio of berry fruit solids to yaupon solids is about 4:1.

8. The blended beverage composition of claim 5, wherein the ratio of berry fruit solids to yaupon solids is about 8:1

9. The blended beverage composition of claim 1, wherein said beverage is a juice blend.

10. The blended beverage composition of claim 1, wherein said beverage is wine.

11. The blended beverage composition of claim 1, wherein said beverage is an herbal drink.

12. The blended beverage composition of claim 1, wherein said beverage is tea.
